(19) United States
(12) Patent Application Publication
(10) Pub. No.: US 2005/0255196 A1
(43) Pub. Date: Nov. 17, 2005

(54) Packaging process utilizing reclosable package having pressure-induced reclose seal which becomes stronger at low temperature

(75) Inventors: Slawomir Opuszko, Duncan, SC (US); Tina V. Lorenzo-Moore, Spartanburg, SC (US); Steven Ensley, Piedmont, SC (US)

Correspondence Address: Sealed Air Corporation, P.O. Box 464, Duncan, SC, 29334, US

(73) Assignee: Cryovac, Inc.

(21) Appl. No.: 11/126,879

(22) Filed: May 11, 2005

Related U.S. Application Data
(60) Provisional application No. 60/571,463, filed on May 14, 2004.

(51) Int. Cl. C12C 1/027

(52) U.S. Cl. 426/106

(57) ABSTRACT

A product is packaged in a pressure-reclosable package comprising a multilayer film having a heat-sealable, pressure-reclosable inside layer. The inside layer contains a hyperbranched polyolefin having at least 70 side chain branches per 1000 carbon atoms and a density of up to about 0.885 g/cc, and/or an ethylene/alpha-olefin elastomer having a density of up to about 0.885 g/cc. The package is opened and a portion of the product removed, and a pressure-induced seal is used to re-close the package at a temperature of at least 11° C. The reclosed package is then placed in an environment having a temperature of from about −50° C to +1° C., so that a cooled pressure-reclosed seal at least doubles in strength.

The present invention pertains to packaging articles, particularly articles having a heat seal, as well as to reclosable packaging articles.

It has been discovered that both (a) hyperbranched polyolefin (“HBP”) having a density of up to about 0.875 g/cc, and (b) ethylene/alpha-olefin elastomer having a density of up to about 0.875 g/cc, can provide a film seal layer with the capability of making a pressure-induced reclosable seal which increases in strength as temperature is lowered from room temperature to lower than room temperature. For example, it has been discovered that the presence of hyperbranched polyethylene and/or ethylene/alpha-olefin elastomer, when present in a film seal layer, can provide a pressure-induced reclosable seal which has a strength that increases by a factor of at least 2 when the seal is cooled from room temperature to 0° C., and which increases in strength by a factor at least 4 when the seal is cooled from room temperature to −23° C. This characteristic is particularly useful in combination with the ability to press as much of the inside surface to itself as possible, thereby decreasing the amount of air in contact with the product in the package, especially when the product is adversely affected by the presence of oxygen. Such products include food product.

As a first aspect, the present invention is directed to a process for preparing and using a packaged product. A product is packaged in a pressure-reclosable package which substantially surrounds the product. The reclosable package comprising a multilayer film comprising a heat-sealable, pressure-reclosable inside layer comprising at least one member selected from the group consisting of: (i) a hyperbranched polyolefin having at least 70 side chain branches per 1000 carbon atoms and a density of up to about 0.885 g/cc; and (ii) an ethylene/alpha-olefin elastomer having a density of up to about 0.885 g/cc. The hyperbranched polyolefin preferably has a density of up to about 0.88 g/cc, more preferably up to about 0.875 g/cc, more preferably up to about 0.87 g/cc, more preferably up to about 0.865 g/cc, and more preferably of up to about 0.86 g/cc, and preferably the hyperbranched polyolefin has a density of at least 0.84 g/cc. The ethylene/alpha-olefin elastomer preferably has a density of up to about 0.88 g/cc, more preferably up to about 0.875 g/cc, more preferably up to about 0.87 g/cc, more preferably up to about 0.865 g/cc, and more preferably of up to about 0.86 g/cc, and preferably the hyperbranched polyolefin has a density of at least 0.83 g/cc, more preferably at least 0.84 g/cc. The multilayer film further comprising a second layer having a polymeric composition which is different from the polymeric composition of the first layer.

The reclosable package is closed by sealing the inside layer to itself and/or a different component of the package so that a closed package is produced. Although the package can be closed by pressure-induced sealing of the inside layer to itself and/or the different component of the package, preferably the package is closed by heat-sealing the inside layer to itself and/or the different component of the package.

The package is then opened, whereby an opened package is formed.

At least a portion of the product which is to be used or consumed is then removed from the package, with a remainder of the product being left inside the opened package and/or returned to the opened package.

The package is then re-closed by pressing the pressure-reclosable inside layer against itself or any other component of the package. The re-closing of the opened package being carried out while at least a portion of the multilayer film which is being re-closed is at a temperature of at least 11° C. The re-closing of the package forms a pressure-induced seal of the inside layer to itself or any other component of the package, whereby a pressure-reclosed package is formed. The pressure-reclosed seal has an initial seal strength at room temperature of from about 0.05 pounds force per inch to about 2 pounds force per inch. Preferably, the pressure-reclosed seal has an initial seal strength at room temperature of from about 0.1 to 2 lbf/in; more preferably from about 0.2 to 2 lbf/in; more preferably from about 0.3 to 2 lbf/in; more preferably from 0.3 to 1.5 lbf/in.

The resulting pressure-reclosed package is then placed in an environment having a temperature of from about −50° C. to +10° C., so that a cooled pressure-reclosed seal is formed, the cooled pressure-reclosed seal having a seal strength of at least double (for example, at least 4 times, or at least 6 times, or from 4 to 6 times, or from 2 to 50 times, or from 4 to 30 times, or from 6 to 25 times) the initial seal strength. The cooled re-closed seal having a seal strength of from about 2 pounds force per inch to about 20 pounds force per inch (alternatively, from 3 to 15 lbf/in, or 4 to 12 lbf/in).

In one embodiment, the package is closed by hermetically heat sealing the inside layer to itself or the different component of the package.

In one embodiment, the heat-sealable, pressure-reclosable inside layer comprises a blend which comprises: (A) from about 15 to 99 percent, based on layer weight, (preferably from about 30 to 99 weight percent, 50 to 99 weight percent; more preferably from about 60 to 99 weight percent; more preferably from about 70 to 99 weight percent; more preferably 90-99%) of at least one member selected from the group consisting of the homogeneous hyperbranched polyolefin and the ethylene/alpha-olefin elastomer; and (B) from about 1 to about 85 percent, based on layer weight (preferably from about 1 to 70 weight percent, more preferably from 1 to 50 weight percent, more preferably from about 1 to 30 weight percent; more preferably from about 1 to 10 weight percent), of at least one polymer selected from the group consisting of an olefin homopolymer having a density of at least 0.88 g/cc (preferably from 0.89 to 0.96 g/cc, more preferably from 0.89 to 0.92 g/cc) and an olefin copolymer having a density of at least 0.88 g/cc (preferably from 0.88 to 0.96 g/cc, more preferably from 0.89 to 0.92 g/cc).

In one embodiment, the olefin copolymer in the blend comprises ethylene/alpha-olefin copolymer having a density of from 0.88 g/cc to 0.96 g/cc. [0.89-0.93; 0.90-0.92]

In one embodiment, the ethylene/alpha-olefin elastomer comprises a homogeneous copolymer of ethylene and an alpha-olefin having from 4 to 20 carbon atoms; more preferably, from 4 to 12 carbon atoms; more preferably, from 4 to 8 carbon atoms. Preferably, the homogeneous copolymer comprises metallocene-catalyzed ethylene/alpha-olefin copolymer. In one embodiment, the metallocene-catalyzed ethylene/alpha-olefin copolymer comprises linear homogeneous ethylene/alpha-olefin copolymer. In another embodiment, the metallocene-catalyzed ethylene/alpha-olefin copolymer comprises long chain branched homogeneous ethylene/alpha-olefin copolymer.

In one preferred embodiment, the homogeneous hyperbranched polyolefin comprises hyperbranched ethylene homopolymer. In another preferred embodiment, the homogeneous hyperbranched polyolefin comprises a homogeneous copolymer of ethylene and at least one member selected from the group consisting of propylene, butene, hexene, and octene.

Preferably, when the pressure-reclosable inside layer is pressed against itself or the different component of the package at a pressure of at least 40 psi for one second at a temperature of 30° C., the pressure-reclose seal has a seal strength of at least 100 grams per centimeter. Preferably, the pressure-reclose seal has a seal strength of at least 100 grams per centimeter for at least 2 repetitions, more preferably for at least 3 repetitions, more preferably for at least 4 repetitions, more preferably for at least 5 repetitions, repetitions.

In one embodiment, the multilayer film further comprises a third layer which serves as an O₂-barrier layer.

In one embodiment, the hyperbranched polyolefin has from about 70 to about 140 side chain branches per 1000 carbon atoms; more preferably from 70 to 130 side chain branches per 1000 carbon atoms; more preferably from 70 to 130 side chain branches per 1000 carbon atoms; more preferably from 70 to 120 side chain branches per 1000 carbon atoms; more preferably from 70 to 110 side chain branches per 1000 carbon atoms; more preferably from 70 to 100 side chain branches per 1000 carbon atoms; more preferably from 70 to 90 side chain branches per 1000 carbon atoms; more preferably from 72 to 88 side chain branches per 1000 carbon atoms.

Preferably, the second layer comprises at least one member selected from the group consisting of polyolefin homopolymer, ethylene/alpha-olefin copolymer, polyamide, polyester, ethylene/vinyl alcohol copolymer, halogenated polymer, polystyrene, polynorbomene, ethylene/ester copolymer, and ethylene/unsaturated acid polymer.

Preferably, the hyperbranched polyolefin comprises hyperbranched polyethylene having a density of from about 0.85 to about 0.87 g/cm³.

Preferably, the heat-sealable, pressure-reclosable layer comprises hyperbranched polyolefin in an amount of 100 percent, based on layer weight.

In one embodiment, the heat-sealable, pressure-reclosable layer comprises the ethylene/alpha-olefin elastomer an amount of 100 percent, based on layer weight.

In one embodiment, the multilayer film has a total free shrink, at 185° F., of at least 10 percent; more preferably from 10 to 150 percent; more preferably from 15 to 120 percent; more preferably from 15 to 100 percent; more preferably from 20 to 90 percent. Alternatively, the total free shrink at 185° F can be from 0 to less than 10 percent, or from 0 to less than 5 percent.

The multilayer film can have a thickness of from about 0.3 to about 25 mils.

The package can comprise at least one member selected from the group consisting of bag, pouch, casing, tray having flange with film lid adhered to flange, formed packaging article, and box.

The product can comprise food, more particularly at least one member selected from the group consisting of meat, cheese, ice cream, produce, dairy products, spices, and condiments.

As a second aspect, the present invention is directed to a process for preparing and using a packaged product, comprising: (A) packaging a product in a reclosable package which substantially surrounds the product, the reclosable package comprising a multilayer film as in the first aspect of the present invention; (B) storing the closed package in a first environment, the first environment being at a temperature of from about −50° C. to 10° C. (preferably, from −20° C. to 9° C; more preferably from −15° C. to 7° C; more preferably, from −10 to 5° C.); (C) moving the closed package from the first environment into a second environment, the second environment being at a temperature of from 11° C. to 45° C.; (D) opening the package while the package is in the second environment, whereby an opened package is formed; (E) removing from the package at least a portion of the product which is to be used or consumed, with a remainder of the product being left inside the opened package and/or returned to the opened package; (F) re-closing the opened package by pressing the pressure-reclosable inside layer against itself or any other component of the package, the re-closing of the opened package being carried out while the package remains in the second environment, the re-closing of the package forming a pressure-induced seal of the inside layer to itself or any other component of the package, whereby a pressure-reclosed package is formed, the pressure-reclosed package substantially surrounding the remainder of the product, the pressure-reclosed seal having an initial seal strength of from about 0.05 pounds force per inch to about 2 pounds force per inch in the second environment; and (G) returning the pressure-reclosed package to the first environment whereby a cooled pressure-reclosed seal is formed, the cooled pressure-reclosed seal having a seal strength of at least double the initial seal strength, the cooled reclosed seal having a seal strength of from about 2 pounds force per inch to about 20 pounds force per inch.

As a third aspect, the present invention pertains to a process for utilizing a packaging article having a reclosable strip component which is adhered to another component of the package, the reclosable strip containing the hyperbranched polyolefin and/or the ethylene/alpha-olefin elastomer on an outer surface which adheres to another component of the package. The third aspect of the invention utilizes in the strip the same polymers utilized in the first layer of the film in accordance with the first and second aspects of the invention.

### BRIEF DESCRIPTION OF THE DRAWINGS

FIG. 1 is an enlarged, schematic, cross-sectional view of a two-layer film suitable for use in the present invention.

FIG. 2 is a schematic of a process for preparing the multilayer film of FIG. 1.

FIG. 3 is a plot of density versus branching level for various homogeneous hyperbranched polyethylenes.

FIG. 4 is a bar chart showing the percent of methyl, ethyl, propyl, butyl, pentyl, and hexyl+ branches in a hyperbranched polyethylene having 83 branches per 1000 carbon atoms.

FIG. 5 is a plot of seal strength versus seal temperature for the hyperbranched polyethylene having 83 branches per 1000 carbon atoms.

FIG. 6 is a plot of seal strength versus reclosable seal repetitions for a pressure-induced reclosable seal of two film strips each having a reclosable seal layer containing the hyperbranched polyethylene having 83 branches per 1000 carbon atoms.

FIG. 7 is a plot of seal strength of a pressure-induced reclosable seal versus branching level for a series of two-layer films having a first layer of hyperbranched polyethylene.

FIG. 8 is a plot of seal strength of a pressure-induced seal versus hyperbranched polyethylene density for a series of two-layer films having a first layer of hyperbranched polyethylene.

FIG. 9 is a plot of branching level versus density of (a) hyperbranched polyethylene and (b) density of ethylene/alpha-olefin elastomer for a series of two layer films having a first layer of containing these polymers.

FIG. 10 is a plot of seal strength at room temperature versus reclose repetitions for a series of two layer films having a pressure-reclosable first layer.

FIG. 11 is a plot of seal strength versus seal temperature for a series of two layer films having a pressure-reclosable first layer.

FIG. 12 is a plot of reclose seal strength versus density for two series of two layer films, a first series having hyperbranched polyethylene in the reclosable layer and the second series having ethylene/alpha-olefin elastomer in the reclosable layer.

FIG. 13 is a bar graph providing the strength of the reclosable seal for a set of two layer films, with the strength of the reclosable seals having been measured at 73° F., 32° F., and −10° F. for each of the films.

### DETAILED DESCRIPTION OF THE INVENTION

As used herein, the phrase “substantially surrounding”, used with respect to the manner in which a package envelops a product therein, includes both hermetic packaging which envelops the product, as well as non-hermetic packaging which envelops the product. In contrast, the term “surrounding”, when describing the manner in which the package envelops the product, refers to packaging which hermetically envelops the product inside the package.

As used herein, the phrase “being at a temperature”, when used with reference to the temperature at which a package is stored or the temperature of a film, or the temperature of a portion of a film, includes any set of temperatures or temperature ranges which include the stated temperature.

As used herein, the phrase “leaving a remainder of the product in the package” includes removing all of the product from the package, and thereafter returning a remainder portion of the product to the package without using the remainder at the time of use of the non-remainder portion of the product.

The multilayer film can have various additional layers including one or more barrier layers, tie layers, abuse layers, bulk layers, modulus layers, abrasion resistant layers, heat-resistant layers, etc. These layers can contain one or more of the various polymers defined herein.

The formation of the packaged product to be utilized in the present invention can be carried out using bags, pouches, or casings, and can use form-fill-and-seal (i.e., “FFS” processes, including both horizontal FFS and vertical FFS). The casings can be seamless or backseamed, and if backseamed, can be fin sealed, lap sealed, or butt sealed with a backseam tape. The bags can be end-seal, side-seal, L-seal. A U-sealed packaging article is considered to be a pouch.

The HBP useful in the present invention preferably has a narrow molecular weight distribution (i.e., Mw/Mn), and preferably is produced using a single site catalyst, i.e., preferably the HBP is a homogeneous HBP. The HBP preferably has a molecular weight distribution less than 3, preferably less than 2.5. However, it is possible to prepare a HBP having greater Mw/Mn using tandem reactor processes which can result in bimodal or multimodal products comprising one or more different polymers.

Preferably, the HBP exhibits a melt index of from about 0.5 to about 10 g/10 min, preferably from about 1 to 9, more preferably from about 1.1 to 8.5, more preferably from about 1.5 to about 7.5. A preferred hyperbranched polyethylene for use in the present invention has a molecular weight (Mw) of from about 70,000 to about 200,000, preferably from about 80,000 to about 150,000.

The HBP may be prepared by methods of synthesis disclosed herein, preferably using nickel (II) a-diimine catalyst complexes. Other methods of preparing the HHP include methods disclosed in U.S. Pat. No. 5,866,663 to Brookhart et al. entitled “Process of Polymerizing Olefins”, hereby incorporated in its entirety, by reference thereto.

The HBP useful in the present invention can alternatively be evaluated via proton NMR or ¹³C NMR. The HBP has at least 70 branches per 1000 carbon atoms, preferably from 70 to 120 side chain branches per 1000 carbon atoms; more preferably from about 70 to 100 side chain branched per 1000 carbon atoms.

Preferably, the HBP present in the film comprises a hyperbranched ethylene homopolymer. In a preferred embodiment, at least one outer layer of the film contains hyperbranched ethylene homopolymer and/or ethylene/alpha-olefin elastomer which may make up 100 percent of the weight of the film layer. Alternatively, the HBP and/or ethylene/alpha-olefin elastomer can be blended with one or more additional polymers and/or additives (such a slip agents, antiblock agents, etc). If another polymer is present, the HBP and/or ethylene/alpha-olefin elastomer preferably comprises at least about 30% of the weight of the layer, more preferably at least about 50%, more preferably at least about 60%, more preferably at least about 70%, more preferably at least about 90%. Preferably, the HBP comprises at least about 50% by weight of the layer. More preferably, the HBP comprises at least about 60% by weight of the layer.

It has been found that in addition to being able to form a pressure-sensitive adhesive bond with itself, the HBP and/or ethylene/alpha-olefin elastomer utilized in the films of the present invention are also capable of forming a hermetic heat seal with itself and other polymers, such as, for example, linear low density polyethylene (LLDPE), very low density polyethylene (VLDPE), ethylene/vinyl acetate copolymer (EVA), ionomer, and to a lesser extent, nylon, polystyrene, and polyethylene terephthalate.

A preferred multilayer film of the present invention has an outer, hermetic heat seal layer containing a homogeneous hyperbranched polyethylene and/or ethylene/alpha-olefin elastomer, which imparts adhesive character to the layer. At least one preferred embodiment of the invention has been found to be capable of adhering to itself repeatedly through many cycles of cold pressure bonding followed by pulling apart, with the adhesive character maintaining an adhesive bond sufficient to afford a pressure-reclosable feature to the packaging. The pressure-reclosability is capable of providing from 2 to 250 pressure-reclose cycles; typically from 4 to 100 cycles, and still more typically from 4 to 25 pressure-reclose cycles.

As used herein, the phrase “pressure-reclosable layer” refers to a film layer that develops an adhesive bond to itself or to other surfaces at room temperature, by applying only a moderate pressure (e.g., 0.5-50 psi for one second at 30° C. or room temperature). Such as bond is also referred to herein as a pressure-induced bond. Such behavior is referred to as a pressure-induced seal, a pressure-induced bond, or a cold seal. The presence of HBP and/or ethylene/alpha-olefin elastomer in the outer heat seal layer of the multilayer film renders the film capable of serving as a pressure-reclosable layer. The film is capable of adhesion to an adherend using light pressure at room temperature, following which the adhesive bond can be broken without leaving substantial residue on the adherend. The HBP and/or ethylene/alpha-olefin elastomer used in the outer layer of the film is capable of serving as a pressure-reclosable seal over a broad temperature range, e.g., from as low as about −30° C. (or lower) to as high as 50° C. However, the HBP and/or ethylene/alpha-olefin elastomer is generally used to make a pressure-reclosable seal at room temperature, i.e., at 20° C to 30° C.

As used herein, the term “film” is used in a generic sense to include plastic web, regardless of whether it is film or sheet, and whether it has been reshaped to a geometry which is no longer planar. Preferably, films of and used in the present invention have a thickness of 0.25 mm or less.

As used herein, the term “package” refers to packaging materials configured around (i.e., enveloping) a product being packaged. The phrase “packaged product,” as used herein, refers to the combination of a product which is surrounded or substantially surrounded by a packaging material.

As used herein, the phrases “inner layer” and “internal layer” refer to any layer, of a multilayer film, having both of its principal surfaces directly adhered to another layer of the multilayer film.

As used herein, the phrase “outer layer” refers to any film layer of film having less than two of its principal surfaces directly adhered to another layer of the film. The phrase is inclusive of monolayer and multilayer films. In multilayer films, there are two outer layers, each of which has a principal surface adhered to only one other layer of the multilayer film. In monolayer films, there is only one layer, which, of course, is an outer layer in that neither of its two principal surfaces are adhered to another layer of the film.

As used herein, the phrase “inside layer” refers to the outer layer of a multilayer packaging film, which is closest to the product cavity, relative to the other layers of the multilayer film. In one embodiment, the inside layer is the pressure-reclosable layer capable of forming a pressure-induced bond. The phrases “pressure-induced bond” and “pressure-induced seal” are used herein interchangeably, and are considered to be equivalent in meaning.

As used herein, the phrases “heat-shrinkable,” “heat-shrink” and the like refer to the tendency of a film, generally an oriented film, to shrink upon the application of heat, i.e., to contract upon being heated, such that the size (area) of the film decreases while the film is in an unrestrained state. Likewise, the tension of a heat-shrinkable film increases upon the application of heat if the film is restrained from shrinking. As a corollary, the phrase “heat-contracted” refers to a heat-shrinkable film, or a portion thereof, which has been exposed to heat such that the film or portion thereof is in a heat-shrunken state, i.e., reduced in size (unrestrained) or under increased tension (restrained).

As used herein, the phrase “free shrink” refers to the percent dimensional change in a 10 cm×10 cm specimen of film, when shrunk at 185° F., with the quantitative determination being carried out according to ASTM D 2732, as set forth in the 1990 Annual Book of ASTM Standards, Vol. 08.02, pp.368-371, which is hereby incorporated, in its entirety, by reference thereto. Preferably, the heat shrinkable film has a total free shrink (i.e., machine direction plus transverse direction), as measured by ASTM D 2732, of at least as 10 percent at 185° C., for example at least 15 percent, at least 20 percent, from 30 to 150 percent, from 30 to 120 percent, from 40 to 110 percent, from 50 to 100 percent, from 60 to 100 percent, from 70 to 95 percent, at 185° F.

As used herein, the phrase “machine direction”, herein abbreviated “MD”, refers to a direction “along the length” of the film, i.e., in the direction of the film as the film is formed during extrusion and/or coating. As used herein, the phrase “transverse direction”, herein abbreviated “TD”, refers to a direction across the film, perpendicular to the machine or longitudinal direction.

As used herein, the term “seal” refers to any seal of a first region of an outer film surface to a second region of an outer film surface, including heat seals as well as pressure-induced seals made at a temperature of less than 50° C. In contrast, the phrase “heat seal” refers to seals made by heating one or more polymeric components in one or more films to at least 50° C., so long as 50° C. is at or above the heat seal initiation temperature of enough of the polymer of the layer that polymer melts and resolidifies at room temperature to form a hermetic seal. Heat-sealing can be performed by any one or more of a wide variety of manners, such as using a heat seal technique (e.g., melt-bead sealing, thermal sealing, impulse sealing, ultrasonic sealing, hot air, hot wire, infrared radiation, etc.). A preferred sealing method uses the same double seal bar apparatus used to make the pressure-induced seal in the examples herein.

As used herein, the term “hermetic seal” refers to both peelable and unpeelable seals which do not permit the flow (as opposed to diffusion) of fluid, especially a gas such as air, and/or a liquid such as water.

As used herein, the phrases “seal layer,” “sealing layer,” “heat seal layer,” and “sealant layer,” refer to an outer film layer, or layers, involved in the pressure-induced sealing and/or heat sealing of the film to itself, another film layer of the same or another film, and/or another article which is not a film.

As used herein, the term “bag” is inclusive of L-seal bags, side-seal bags, end-seal bags, backseamed bags, and pouches. An L-seal bag has an open top, a bottom seal, a seal along a first side edge, and a seamless (i.e., folded, unsealed) second side edge. A side-seal bag has an open top and a seamless bottom edge, with each of its two side edges having a seal therealong. An end-seal bag is made from seamless tubing and has an open top, a bottom seal, and seamless side edges. A pouch has an open top and a bottom seal and a seal along each side edge. Although seals along the side and/or bottom edges can be at the very edge itself, (i.e., seals of a type commonly referred to as “trim seals”), preferably heat seals are spaced inward (preferably ¼ to ½ inch, more or less) from the bag side edges, and preferably are made using impulse-type heat sealing apparatus, which utilizes a bar which is quickly heated and then quickly cooled. A backseamed bag is a bag having an open top, a “backseam” seal running the length of the bag in which the bag film is either fin-sealed or lap-sealed, two seamless side edges, and a bottom seal along a bottom edge of the bag.

As used herein, the term “vacuum skin packaging” refers to a topographic heat seal, as contrasted to a perimeter heat seals. In forming a topographic seal, at least one film is heated and then brought in to contact with another film surface using differential air pressure. The films contour about a product and hermetically bond to one another throughout the region(s) of film-to-film contact. HBP, especially homogeneous hyperbranched polyethylene, as well as ethylene/alpha-olefin elastomers, are especially well-suited to the topographic seals employed in vacuum skin packaging. Vacuum skin packaging is described in U.S. Pat. RE 030009, to Purdue, et al., which is hereby incorporated, in its entirety, by reference thereto.

As used herein, the phrase “heterogeneous polymer” refers to polymerization reaction products of relatively wide variation in molecular weight (M_{w}/Mₙ greater than 3.0) and relatively wide variation in composition distribution, i.e., typical polymers prepared, for example, using conventional Ziegler-Natta catalysts. Heterogeneous copolymers typically contain a relatively wide variety of main chain lengths and comonomer percentages.

As used herein, the phrase “homogeneous polymer” refers to polymerization reaction products of relatively narrow molecular weight distribution (M_{w}/Mₙ less than 3.0) and relatively narrow composition distribution. Homogeneous polymers are useful in various layers of the multilayer film used in the present invention. Homogeneous polymers are structurally different from heterogeneous polymers, in that homogeneous polymers exhibit a relatively even sequencing of comonomers within a chain, a mirroring of sequence distribution in all chains, and a similarity of length of all chains, i.e., a narrower molecular weight distribution. Furthermore, homogeneous polymers are typically prepared using metallocene or other single-site catalysts, rather than, for example, Ziegler Natta catalysts.

More particularly, homogeneous ethylene homopolymers and ethylene/alpha-olefin copolymers may be characterized by one or more processes known to those of skill in the art, such as molecular weight distribution (M_{w}/Mₙ, M_{z}/Mₙ), composition distribution breadth index (CDBI), and narrow melting point range and single melting point behavior. The molecular weight distribution (Mw/Mn), also known as polydispersity, or polydispersity index (“PDI”) may be determined by gel permeation chromatography.

The ethylene alpha-olefin elastomer useful in the invention generally has (M_{w}/Mₙ) of less than 3; preferably less than 2.7, preferably from about 1.9 to 2.5; more preferably, from about 1.9 to 2.3. The composition distribution breadth index (CDBI) of homogeneous ethylene/alpha-olefin copolymers will generally be greater than about 70 percent. The CDBI is defined as the weight percent of the copolymer molecules having a comonomer content within 50 percent (i.e., plus or minus 50%) of the median total molar comonomer content. The CDBI of linear polyethylene, which does not contain a comonomer, is defined to be 100%. The Composition Distribution Breadth Index (CDBI) is determined via the technique of Temperature Rising Elution Fractionation (TREF). CDBI distinguishes the homogeneous copolymers (narrow composition distribution as assessed by CDBI values generally above 70%) from heterogeneous copolymers such as VLDPEs which generally have a broad composition distribution as assessed by CDBI values generally less than 55%. The CDBI of a copolymer is readily calculated from data obtained from techniques known in the art, such as, for example, temperature rising elution fractionation as described, for example, in Wild et. al., J. Poly. Sci. Poly. Phys. Ed., Vol. 20, p. 441 (1982). Preferably, homogeneous ethylene/alpha-olefin copolymers have a CDBI greater than about 70%, i.e., a CDBI of from about 70% to 99%.

Homogeneous ethylene/alpha-olefin copolymer can, in general, be prepared by the copolymerization of ethylene and any one or more alpha-olefin. Preferably, the alpha-olefin is a C₃-C₂₀ alpha-monoolefin, more preferably, a C₄-C₁₂ alpha-monoolefin, still more preferably, a C₄-C₈ alpha-monoolefin. Still more preferably, the alpha-olefin comprises at least one member selected from the group consisting of butene-1, hexene-1, and octene-1, i.e., 1-butene, 1-hexene, and 1-octene, respectively.

Processes for preparing and using linear homogeneous polyolefins are disclosed in U.S. Pat. No. 5,206,075, U.S. Pat. No. 5,241,031, and PCT International Application WO 93/03093, each of which is hereby incorporated by reference thereto, in its entirety. Further details regarding the production and use of linear homogeneous ethylene/alpha-olefin copolymers are disclosed in PCT International Publication Number WO 90/03414, and PCT International Publication Number WO 93/03093, both of which designate Exxon Chemical Patents, Inc. as the Applicant, and both of which are hereby incorporated by reference thereto, in their respective entireties.

Still another genus of homogeneous polyolefins is disclosed in U.S. Pat. No. 5,272,236, to LAI, et. al., and U.S. Pat. No. 5,278,272, to LAI, et. al., both of which are hereby incorporated by reference thereto, in their respective entireties. Each of these patents disclose “substantially linear” homogeneous long chain branched ethylene/alpha-olefin copolymers produced and marketed by The Dow Chemical Company.

Still another species of homogeneous polyolefin is homogeneous hyperbranched polyolefins, which is also a species of HBP. Hyperbranched homogeneous polyethylene, while resembling other homogeneous resins in aspects such as low polydispersity index (M_{w}/Mₙ of less than 3.0, preferably less than 2.7, preferably having a M_{w}/Mₙ of from about 1.9 to 2.5), is structurally different from linear homogeneous polyolefin, such as EXACT® linear homogeneous ethylene/alpha-olefin copolymer and AFFINITY® ethylene/alpha-olefin copolymer having long chain branching, in that it has a side chain branching level of at least 70 branches per 1000 carbon atoms, in addition to the unique population and mixed type and length of the side branch chains.

Hyperbranched polyethylene useful in the present invention has a solid state density (at 25° C.) of up to about 0.875 g/cc, more preferably up to about 0.865 g/cc, more preferably up to about 0.86 g/cc, more preferably up to about 0.860 g/cc. Preferably, the hyperbranched polyethylene has a density of from about 0.85 g/cc to about 0.875 g/cc, more preferably from about 0.86 to about 0.875 g/cc.

As used herein, the phrase “ethylene/alpha-olefin copolymer” refers to both heterogeneous copolymers such as linear low density polyethylene (LLDPE), very low and ultra low density polyethylene (VLDPE and ULDPE), as well as homogeneous copolymers such as linear metallocene catalyzed polymers such as EXACT® resins obtainable from the Exxon Chemical Company, and TAFMER® resins obtainable from the Mitsui Petrochemical Corporation. Ethylene/alpha-olefin copolymers include copolymers of ethylene with one or more comonomers selected from C₄ to C₁₀ alpha-olefin such as butene-1, hexene-1, octene-1, etc. in which the molecules of the copolymers comprise long chains with relatively few side chain branches or cross-linked structures. Other ethylene/alpha-olefin copolymers, such as the long chain branched homogeneous ethylene/alpha-olefin copolymers available from the Dow Chemical Company, known as AFFINITY® resins, are also included as ethylene/alpha-olefin copolymers useful for incorporation into certain film layers of the present invention.

The ethylene/alpha-olefin elastomer which can be used in the film has an ethylene mer content which is at least about 50 mole percent, more preferably from about 60 to about 95 mole percent, more preferably from about 75 to about 90 mole percent. Ethylene/alpha-olefin elastomer has a density of from up to about 0.875 g/cc, more preferably up to about 0.87 g/cc, preferably up to about 0.865 g/cc, more preferably up to about 0.86 g/cc. Preferably, the ethylene/alpha-olefin copolymer has a density of from about 0.83 to about 0.875 g/cc, more preferably from about 0.84 to about 0.875 g/cc. Preferably, the ethylene/alpha-olefin elastomer has a melt index of from about 0.5 to 20 grams per 10 minutes, more preferably from about 1 to 15 grams per 10 minutes.

Although the film of the present invention can be a monolayer film laminated or extrusion-coated to at least one other film layer to form a multilayer film, in one preferred embodiment the multilayer film is a coextruded film having homogeneous hyperbranched polyethylene present in one or more of the outer layers of the film.

Preferably, the film according to the present invention comprises a total of from 2 to 20 layers; more preferably, from 2 to 12 layers; more preferably, from 2 to 9 layers; more preferably, from 3 to 8 layers. Various combinations of layers can be used in the formation of a multilayer film according to the present invention. Given below are some examples of preferred multilayer film structures in which letters are used to represent film layers (although only 2-through 5-layer embodiments are provided here for illustrative purposes, further layers could be present):
A/B,
A/C,
A/B/A,
A/B/B′,
A/B/C,
A/B/C/B,
A/B/C/B′,
A/B/C/B/A,
B/A/C/B/A
B/A′/C/B/A
wherein
   A represents a layer that includes the Homogeneous hyperbranched polyethylene described above, in a blend with another polymer, particularly an ethylene/alpha-olefin copolymer;
   B represents a layer including at least one member selected from the group consisting of polyolefin (particularly an ethylene/alpha-olefin copolymer), polyester (including polycarbonate), polyamide, polyaromatic (particularly polystyrene), poly(phenol-formaldehyde), and poly(amine-formaldehyde)), polyether, polyimide, polyimine, polyurethane, polysulfone, polyalkyne and ionomer; and
   C represents a layer including a polymer serving as an oxygen barrier layer, e.g., polyvinylidene chloride “PVDC” (PVDC homopolymer and/or methyl acrylate copolymer “PVDC-MA” and/or vinyl chloride copolymer “PVDC-VC”), ethylene/vinyl alcohol copolymer (“EVOH”), polyamide, etc.

As required, one or more tie layers can be used between any one or more layers of in any of the above multilayer film structures. Also, while “A” is a HBP and/or ethylene/alpha-olefin elastomer in the above structures, “A′” is a different HBP and/or ethylene/alpha-olefin elastomer, and so on, whereas a film having two “B” layers (as opposed to B and B′) could have the same B polymer(s) or different B polymer(s), in the same or different amounts and/or ratios with respect to one another and with respect to the multilayer film as a whole.

In general, the multilayer film(s) used in the present invention can have any total thickness desired, so long as the film provides the desired properties for the particular packaging operation in which the film is used, e.g. abuse-resistance (especially puncture-resistance), modulus, seal strength, optics, etc. Preferably, the film has a total thickness of up to about 50 mils, more preferably the film has a total thickness of from about 0.5 to about 40 mils, more preferably from about 2 to about 20 mils, more preferably from about 1 to about 15 mils.

As used herein, the phrase “packaging article” is used with reference to bags, pouches, casings, trays and other thermoformed articles, etc., which are useful for packaging one or more products.

As used herein, the term “barrier”, and the phrase “barrier layer”, as applied to films and/or film layers, are used with reference to the ability of a film or film layer to serve as a barrier to the passage of one or more gases. In the packaging art, selective oxygen (i.e., gaseous O₂) barrier layers have included, for example, hydrolyzed ethylene/vinyl acetate copolymer (designated by the abbreviations “EVOH” and “HEVA”, and also referred to as “ethylene/vinyl alcohol copolymer”), polyvinylidene chloride (“PVDC”), especially PVDC-methyl acrylate copolymer (“PVDC-MA”), and PVDC-vinyl chloride copolymer (“PVDC-VC”), as well as polyamide, polyester, polyalkylene carbonate, polyacrylonitrile, etc., as known to those of skill in the art.

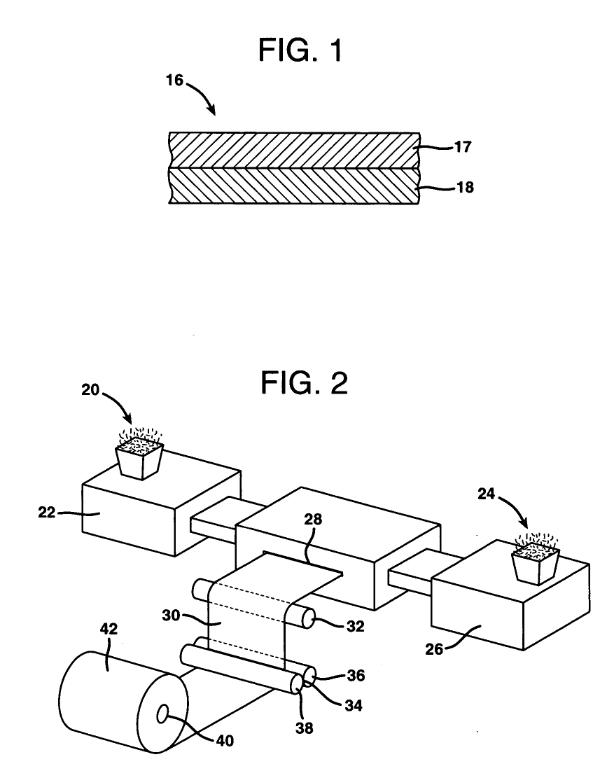

FIG. 1 illustrates an enlarged, schematic cross-sectional view of two-layer film 16 for use in the present invention. Two-layer film 16 contains first layer 17 and second layer 18, both of which are outer film layers. First layer 17 is a heat-sealable, pressure-reclosable layer, and second layer 18 contains a different polymeric composition from the polymeric composition of first layer 17.

The heat-sealable, pressure-reclosable film suitable for use in the process of the present invention can be produced by the process illustrated in FIG. 2. In FIG. 2, polymer pellets 20 of a first polymer are fed into first extruder 22 and polymer pellets 24 of a second polymer are fed into and through second extruder 26. While in extruders 22 and 26, pellets 20 and 24 are subjected to heat and shear, and are consequently melted and degassed so that a molten polymer stream emerges from extruders 22 and 26. The molten polymer streams are fed into slot die 28, with the streams emerging from slot die 28 as a molten two-layer cast film 30. Shortly after emerging from slot die 28, molten two-layer cast film 30 is quenched before or during contact with first roller 32 (which optionally can be cooled), with cast film 30 solidifying while on roller 32, and with cast film 30 making a partial wrap around roller 32. The now solidified cast film 32 is forwarded off of roller 32 and into nip 34 between nip rollers 36 and 38, which serves to forward cast film 30 and to maintain tension on cast film 30 downstream of first roller 32. Thereafter, cast film 30 makes a partial wrap around nip roller 38, and is thereafter wound onto core 40 to result in a film roll 42.

Alternatively, an annular die can be used to make a film suitable for use in the process of the present invention. Quenching of the molten extrudate emerging from the die can be accomplished with cascading water or by casting directly into a cooled water bath. Although a simple cast film can be produced in this manner, on the other hand, a film suitable for use in the process of the present invention can be produced using a sequential casting, quenching, reheating, and orientation process. The film can be cast from an annular (or slot) die with the extrudate being quenched to cause cooling and solidification, followed by being reheated to a temperature below the melt point (preferably to the softening point of the film), followed by solid-state orientation using a tenter frame (i.e., for a flat film extruded through a slot die) or using a trapped bubble (i.e., for an tubular film extruded through an annular die). The annular extrudate, commonly called a “tape” can be quenched using cascading water, cooled air (or other gas), or even ambient air. The resulting solidified and cooled tape is then reheated to a desired orientation temperature and oriented while in the solid state, using for example, a trapped bubble. Films which are oriented in the solid state are considered to be heat-shrinkable, as they have a total free shrink (L+T) at 185° F. of greater than 10 percent.

The multilayer film can also be prepared using a lamination process or an extrusion coating process.

Alternatively, the heat-sealable, pressure-reclosable films suitable for use in the process of the present invention can be produced using a hot blown process in which the film is extruded through an annular die and immediately hot blown by a forced air bubble, while the polymer is at or near its melt temperature. Such hot blown films exhibit a total (i.e., longitudinal plus transverse) free shrink at 185° F. of less than 10 percent, generally no more than 5 percent in either direction. Such hot blown films are not considered to be heat-shrinkable films because the amount of heat-shrinkability is not high enough to provide the advantageous shrink character typically required of heat-shrinkable films. Although hot blown films are oriented, the orientation occurs in the molten state, without producing the orientation-induced stress recognized in the art as that which renders the film heat-shrinkable.

As is known to those of skill in the art, various polymer modifiers may be incorporated into certain film layers for the purpose of improving toughness and/or orientability or extensibility of the multilayer film. Modifiers which-may be added to certain layers within the films of the present invention include: modifiers which improve low temperature toughness or impact strength, and modifiers which reduce modulus or stiffness. Exemplary modifiers include: styrene-butadiene, styrene-isoprene, and ethylene-propylene.

Regardless of the structure of the multilayer film of the present invention, one or more conventional packaging film additives can be included therein. Examples of additives that can be incorporated include, but are not limited to, antiblocking agents, antifogging agents, slip agents, colorants, flavorings, antimicrobial agents, meat preservatives, and the like. Where the multilayer film is to be processed at high speeds, inclusion of one or more antiblocking agents in and/or on one or both outer layers of the film structure can be provided. Examples of useful antiblocking agents for certain applications are corn starch and ceramic microspheres.

Various homogeneous hyperbranched ethylene polymers were prepared using the process described below, and in accordance with, the process described in U.S. Pat. No. 5,866,663 to Brookhart et al. Hyperbranched polyolefins include polyethylenes with 70+ branches per 1000 carbon atoms. Such polyethylenes have good cold tack properties and have been found to be suitable for use in reclosable sealant layers in packaging films. These materials can be sealed at room temperature (i.e., with a pressure-induced seal) and thereafter opened and then resealed with only thumb pressure. The strength of the reclosable seal is affected by the degree of branching in HBPE and the thickness of the sealant layer.

Various hyperbranched polyethylenes were prepared and evaluated for reclosable sealing properties. The degree of branching ranged from 72 to 99 branches per 1000 carbon atoms. HBPE-99 formed the strongest reclosable pressure-induced seal at 30° C. and 40 psi for 1 second (1.5 to 2.5 pounds per inch through 10 closing-opening cycles). This material was very tacky and difficult to handle. Productivity of the catalyst to synthesize such highly branched polymer is inversely proportional to the branching level. A preferred hyperbranched polyethylene for production has a branching level of from about 82 to 85 branches per 1000 carbon atoms. At this branching level productivities of the catalyst are higher and the polymer is useful for film having reclosable character due to enhanced tack, but the polymer is more difficult to handle and process. Hyperbranched polyethylene can be synthesized using the Ni(II) based α-diimine catalyst according to the following procedure.

Small Scale Polymerization of Hyperbranched Polyethylene

The various reagents used in the polymerization were purified as follows. Anhydrous toluene (99.9%, Burdick & Jackson) was transferred to a five gallon tank by passing through a column of activated molecular sieves and neutral alumina under an argon atmosphere. Methylene chloride (anhydrous, 99.9%, Aldrich) was purchased in sure seal bottle, stored under argon atmosphere and used as received. Methylaluminoxane (MAO) 10.3 wt % Al solution in toluene was purchased from Akzo-Nobel and used as received. Ethylene (Air Products, CP grade) was purified by passage through a column containing molecular sieves (3A, 4-8 mesh) and copper catalyst (BASF-R3-11).

The nickel(II) catalyst used in the polymerization had the following structure:

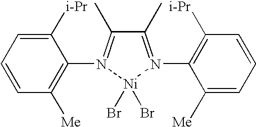

The polymerization was conducted by transferring a quantity of toluene (usually 1L) to a jacketed 2L zipperclave reactor, equipped with an overhead helical impeller. The reactor was vented, evacuated briefly and ethylene gas was admitted. The reactor was allowed to equilibrate at low pressure (1-2 psig) and set temperature (45° C.). Polymerization was triggered by the syringe injection of the quantity of MAO (1.5 mL) followed by the injection of catalyst (27 mg) dissolved in dry methylene chloride (10 mL). The reaction was allowed to proceed with ethylene fed on demand to maintain the desired pressure (20 psi) for 45 to 75 minutes, depending on the polymerization rate.

Polymerization was terminated by venting the reactor and discharging the contents into a 4L Waring blender containing 1L of methanol. The discharged material was vigorously agitated and filtered through Buchner funnel. Polymer was washed with acidified methanol, to remove aluminum ash, and dried in vacuum oven at 40 to 60 C. 70 to 9.0 g of polymer was collected.

The polymer was an amorphous, elastic, rubbery solid, which formed a rubbery fluff after being chopped by a blender. The molecular weight (Mw) was in the range of 120,000 to 130,000, and the polydispersity index (PDI) was about 2.0. The melt flow index (MFI) was in the range of from 1.5 to 2.5 dg/min. The density was about 0.857g/cc. The nickel residue in HBPE-83 synthesized at the conditions described in the above procedure was 0.0035% by weight (35 ppm). For comparison the nickel residue in the HBPE-99 was 0.011 wt % (110 ppm).

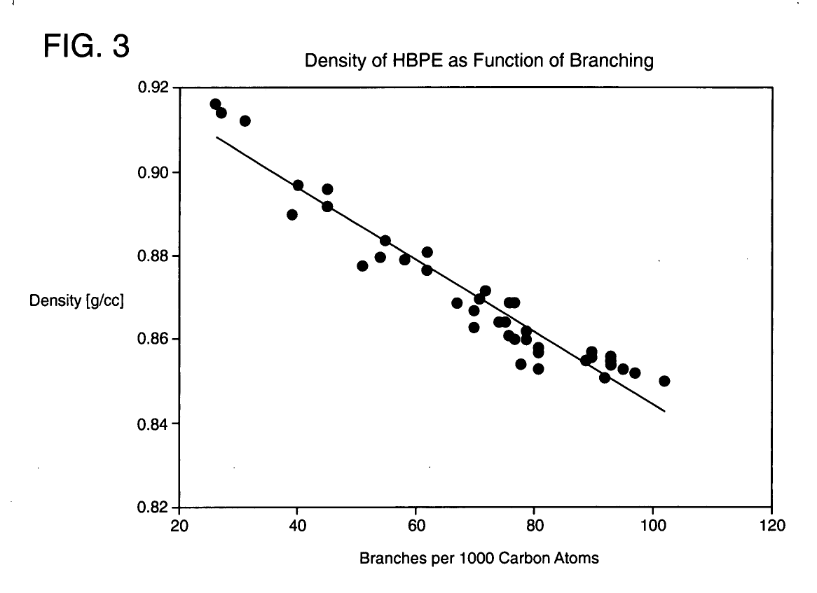

Several HBPE's were polymerized in accordance with the procedure described above. The branching level was varied primarily by controlling the pressure and temperature in the polymerization reactor. For example, to obtain a branching level of 100 branches per 1000 carbon atoms, the temperature and pressure in the reaction vessel were 55° C. and 15 psi; to obtain a branching level of about 60 branches per 1000 carbon atoms, the temperature and pressure were 30° C. and 15 psi. FIG. 3 shows the branching level of various HBPE's polymerized, and also correlates branching level with density for the HBPE's polymerized.

### EXAMPLE 1

A two-layer film was coextruded on a Randcastle Extrusion System laboratory scale extruder, model RC 0625, having a 6 inch slot die and utilizing two extruders. Upon emerging from the slot die, the extrudate was deposited onto and made a partial wrap around a first roller and then through a set of nip rollers and then was wound up to form a roll, in the process illustrated in FIG. 2 (described above). The first roller was not chilled, but rather was allowed to equilibrate to a temperature between the ambient environment and the temperature of the extrudate. Whether the first layer emerged from the die on top of the second layer (i.e., with the second layer coming into direct contact with the first roller), or beneath the second layer (i.e., with the first layer coming into direct contact with the first roller), was found to make substantially no difference in the properties of the resulting film.

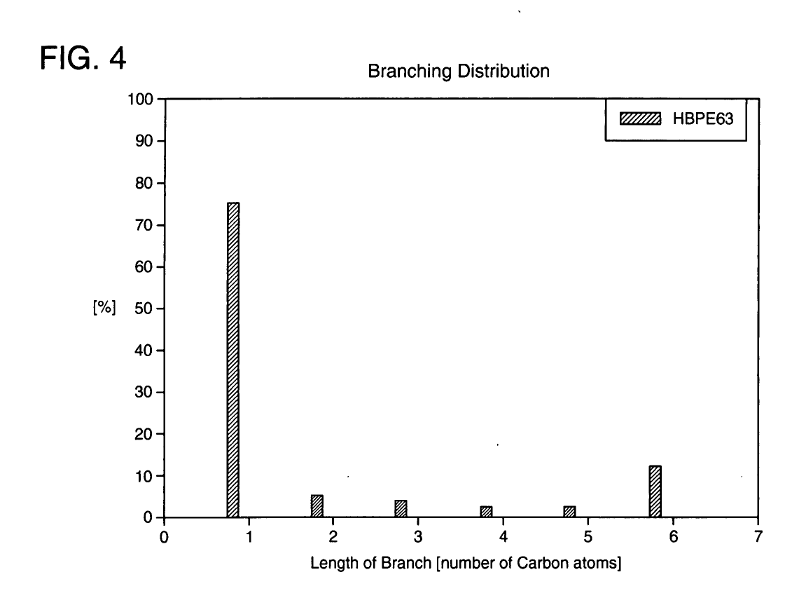

The first film layer of the two-layer film contained 100 weight percent of a homogeneous hyperbranched polyethylene (i.e., “HBPE”) having 83 side chain branches per.1000 carbon atoms and a density of 0.860 g/cc, and a melt index of 1.6 decigrams per minute, and a Mw (i.e., weight average molecular weight) of 132,000, a Mn (i.e., number average molecular weight) of 64,000, an Mz of 228,000, and Mz+1 of 351,000, and Mv of 117,000, a PDI of 2.1, this polymer having been prepared using the process described above. The polymerization process used to make the HBPE is in accordance with U.S. Pat. No. 5,866,663, to Brookhart et al, which is hereby incorporated, in its entirety, by reference thereto. NMR analysis of the hyperbranched polyethylene indicated that 70% to 75% of the branched to be one-carbon branches (i.e., methyl branches), with 10% to 12% of the branches having a length of 6 carbons or longer. The remaining 13% to 20% of the branches had a length of from 2 to 5 carbon atoms. FIG. 4 shows the branching distribution of the HBPE having 83 branches per 1000 carbon atoms.

The second film layer contained 100 weight percent. Fortiflex® T60-500-119 high density polyethylene having a density of 0.961 gm/cc and a melt index of 6.0 decigrams/minute, obtained from BP Chemicals. Each of the two layers had a thickness of 2 mils, with the two layer film having a total thickness of 4 mils. FIG. 1, described above, illustrates a cross-sectional view which corresponds with the two-layer film of this example.

After the two-layer, 4-mil film was extruded and wound up, 36 one-inch wide, ten-inch long strips were cut from the extruded multilayer film made on the Randcastle® Extrusion System laboratory scale extruder. The length of each of the strips corresponded with the machine direction of the extruded multilayer film. The film strips were taken from the central region of the multilayer film, which had a total width of about 5.5 inches. The central 3 inches of the 5.5 inch wide film provided three film strips each one inch wide. The heat seal layers (i.e., the first layer) of the strips of film were heat sealed transversely to one another to form sealed pairs of strips.

The heat seal was made using a Sencorp® Double Bar Sealer, Model No. 128SL/1, using ⅜-inch wide seal bars (one seal bar above the pair of film strips to be sealed, the other seal bar below the pair of film strips), to seal two strips together across their width. Both the upper seal bar and the lower seal bar were heated to 30° C. to make a pressure-induced seal by exerting a pressure of 40 psi (a seal made at 30° C. is not considered to be a “heat” seal, but rather is considered to be a “pressure-induced” seal, in spite of the fact that 30° C. is a little above room temperature). The overlapping strips of film were contacted by the upper and lower seal bars for a dwell time of 1 second, with the overlapping film strips being subjected to a pressure of 40 psi between the seal bars. The resulting pressure-induced seal had a length of one inch (i.e., the one-inch width of the overlapping film strips) and a width of 0.375 inch (i.e., the width of the seal bars). The resulting pressure-induced seal had a total area of 0.375 square inch.

Of the resulting 18 pressure-bonded pairs of film strips: (a) 3 were stored for 1 hour at room temperature, i.e., 22.8° C., (b) 3 were stored for 24 hours at room temperature, (c) 3 were stored for 1 hour at a temperature near refrigeration temperature(i.e., 0° C.), (d) 3 were stored for 24 hours at 0C, (e) 3 were stored for 1 hour at a temperature near freezer temperature (i.e., at −23.3° C.), and (f) 3 were stored for 24 hours at −23.3° C. The seal strength was then measured in accordance with the procedure set forth in ASTM F88, i.e., with an Instrone tensile testing instrument, using an appropriate range load cell, with the seal strength results being reported as maximum load in the units of pounds force per inch, i.e., lbf/in. The seal strength was measured after the stored pairs of film strips were placed in an environmental test chamber for 30 minutes, with the temperature of the environmental test chamber being substantially the same as the temperature as the storage environment. The seal strength testing instrument pulled the strips apart at the pressure-induced seal during the measurement of the strength of the pressure-induced seal.

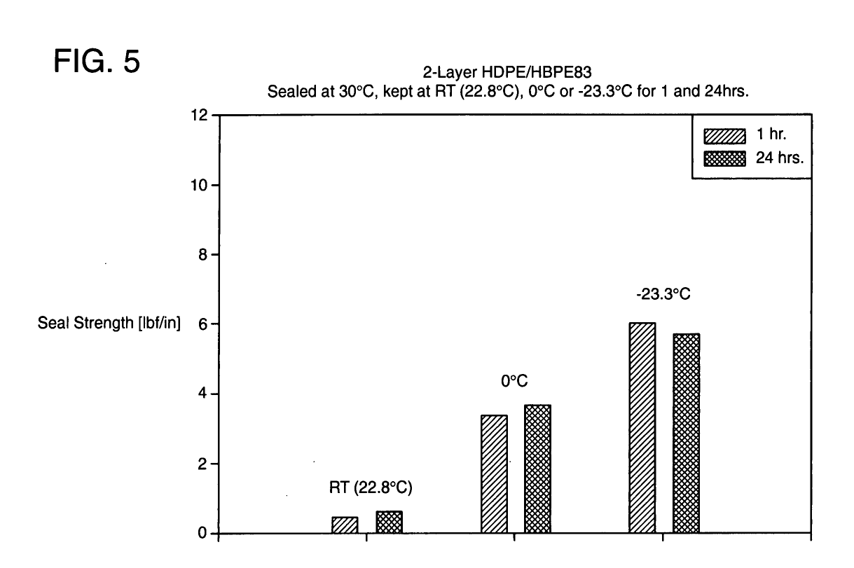

FIG. 5 illustrates the seal strength results for the film strips (a)-(f), above, sealed and stored as described in the paragraph immediately above. As is apparent from FIG. 5, the lower the storage temperature of the pressure-induced seals bonding the pairs of film strips, the higher the strength of the pressure-induced seal. However, at both 0° C. and −23.3° C., the film fractured during the process of measuring the seal strength, i.e., the seal itself did not pull apart, as it did at 22.8° C. Apparently, the strength of the seal increased so much that the strength of the pressure-induced seal exceeded the strength of the film when the film was subjected to the seal strength measurement process. While the pressure-induced seals stored at room temperature exhibited seal strengths within the “easy-open” range, i.e., the samples exhibited a seal strength of from about 0.5 pounds force per inch (i.e., lbf/in) to about 0.7 lbf/in, the seal strength of the seals stored at 0° C. was in excess of five times higher (i.e., 3.2 lbf/in and 3.5 lbf/in) than the seal strength at room temperature, as the film fractured at 3.2 to 3.5 lbf/in before the seal pulled apart. Similarly, the seal strength of the seals stored at −23.3° C. was in excess of 10 times higher than the seal strength at room temperature, as the film fractured at about 6 lbf/in, which also occurred before the seal pulled apart. As can be seen by comparing the relative heights of the pairs of bars in FIG. 3, as to the storage of the pairs of film strips for one hour versus 24 hours, there was not much difference in the strength of the pressure-induced seals.

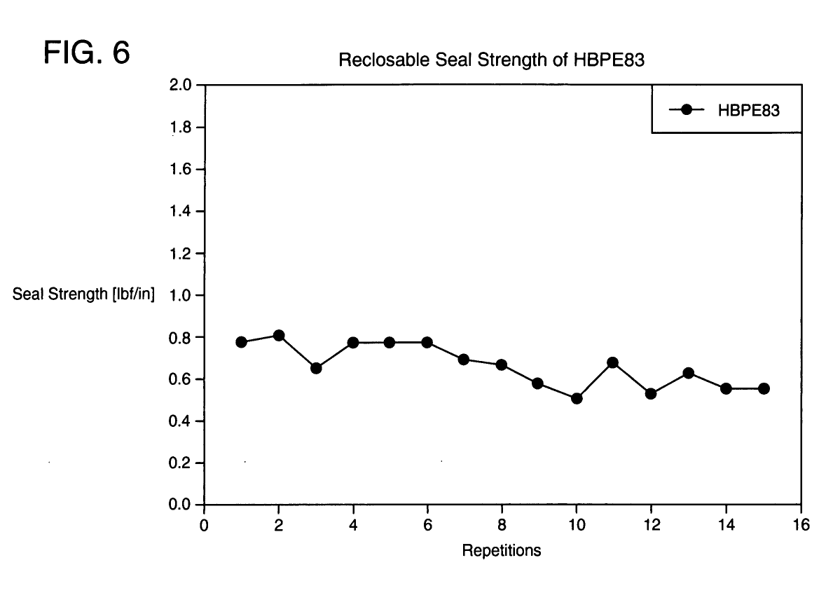

The reclosability (i.e., repeated pressure-induced sealing of the same area of the film) of the two-layer film of Example 1 was analyzed by making a pressure induced seal at 30° C. and 40 psi for one second using a pair of strips as described above and the process as described above, followed by aging the bonded pair of for at least 1 hour, followed by measuring the seal strength of the seal at room temperature, i.e., 22.8° C. After the strips were pulled apart during the seal strength measurement, the same strips were again subjected to pressure-induced sealing at 30° C. and 40 psi for one second, aged for at least one hour, and then retested for seal strength in the same manner. This process was repeated for 14 sealing repetitions, with the seal strength results for each repetition being set forth in FIG. 6.

### EXAMPLE 2

Several of the HBPEs polymerized were used to make 2-layer, 4-mil films in which both layers had a thickness of 2 mils. The films were then cut into strips as described above, and the first layer of each of strip of each pairs of strips of the same film were subjected to pressure-induced sealing to one another, again at 30° C., and 40 psi for one second, using the apparatus identified above. The resulting pressure-induced seal was then allowed to age for at least 1 hour and then subjected to seal strength testing in the manner described above.

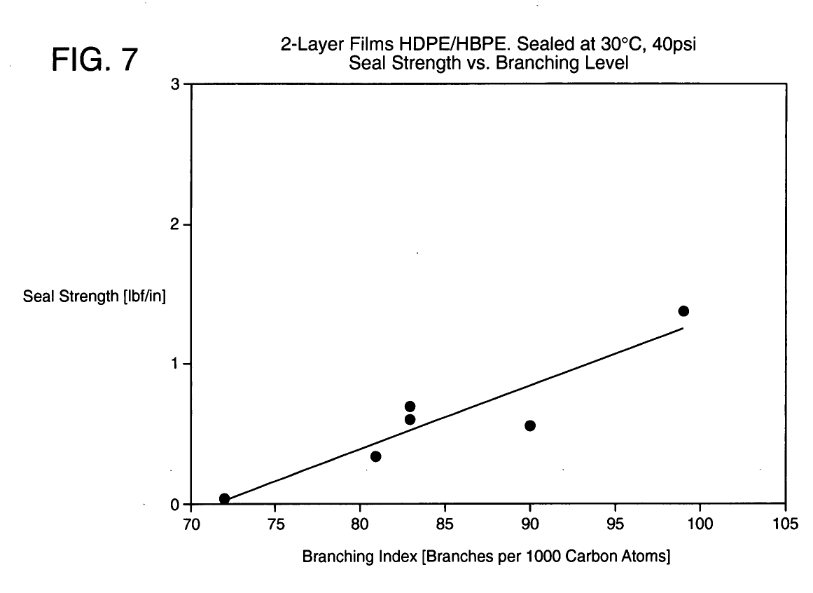

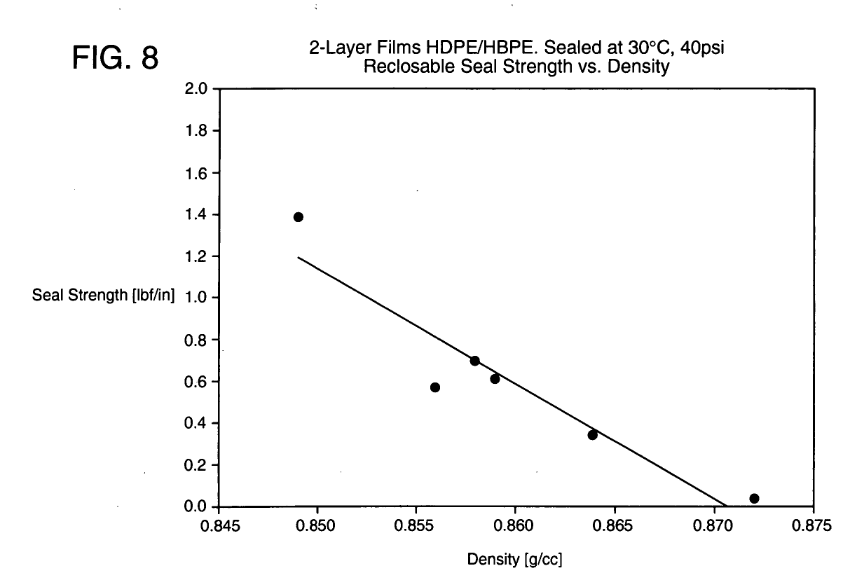

The results of the seal strength testing are set forth in FIG. 7, which is a plot of branching level versus seal strength. As can be seen from FIG. 7, the higher branching level produced a higher pressure-induced seal. It should be noted that each of the pressure-induced seals was a “virgin” seal of the area sealed, i.e., not a repetition of an earlier pressure-induced seal. Several films were also tested for seal strength as a function of density of the HBPE in the first layer of the film. The results of this seal strength testing is set forth in FIG. 8., which is a plot of density versus seal strength.

As can be seen from the seal strength results in FIG. 7 and FIG. 8, there is a correlation between pressure-induced seal strength at room temperature and both branching level (FIG. 7) and density (FIG. 8). The slope of the curves derived from this data indicates that, for example, a HBPE density below 0.86 g/cc provides higher pressure-induced seal strength (at room temperature) than a density above 0.86 g/cc.

### EXAMPLE 3

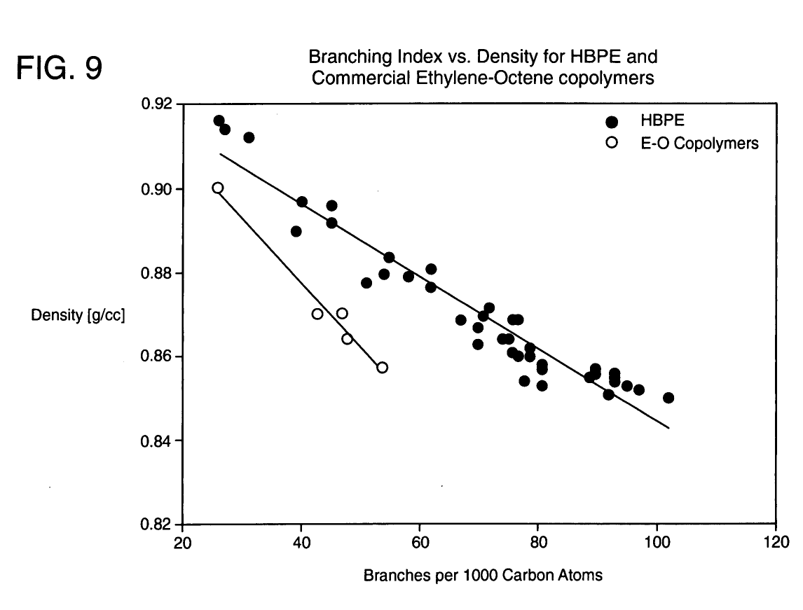

Polymers useful in the present invention have been discovered to include polyolefin elastomers in addition to HBPE's. The branching level of several commercially-available polyolefin elastomers was measured. FIG. 9 is a plot of branches per 1000 carbon atoms versus density for a variety of both HBPE's and ethylene/alpha-olefin copolymer elastomers (i.e., one species of polyolefin elastomer). The elastomers included in FIG. 9 are copolymers of ethylene and 1-butene, 1-hexene, or 1-octene.

The highest branching level found in currently available commercial ethylene-octene copolymers is 54 branches per 1000 carbon atoms. While HBPE's having 54 branches per 1000 carbon atoms were not tacky and did not exhibit the capability to produce pressure-induced seals, elastomers at this level did exhibit the capability of producing pressure-induced seals. This may be because each of the elastomers tested was a copolymer having branches all of which were the same length (though different elastomers had branches of different lengths), which may affect density differently than branching in the HBPE's. Clearly, every HBPE polymerized included branches having differing lengths (again, see FIG. 4). As is evident from FIG. 9, the ethylene/alpha-olefin elastomer having 54 branches per 1000 carbon atoms had a density of only 0.857 g/cc.

The reclosable seal strength of various polyolefin elastomers was measured. Table 1, below, identifies various commercially-available ethylene/alpha-olefin elastomers which have been discovered to be useful in the present invention, as well as one ethylene/alpha-olefin elastomer which is does not exhibit enough tack to be useful in the process of the present invention.

TABLE 1

| | | | Branches | | |
|---|---|---|---|---|---|
| Ethylene/alpha- | Comonomer | Density | per 1000 C | MFI | |
| olefin elastomer | type/wt % | (g/cc) | Atoms | (dg/min) | Reclosability |
| Affinity ® EG | 1-octene/ | 0.870 | 47 | 1.0 | Some |
| 8100 | 37 | | | | |
| Affinity ® EG | 1-octene/ | 0.870 | 43 | 5.0 | Some |
| 8200 | 34 | | | | |
| Engage ® 8130 | 1-octene/ | 0.864 | 49 | 13.0 | moderate to high |
| | 38 | | | | |
| Engage ® 8842 | 1-octene/ | 0.857 | 54 | 1.0 | Excellent |
| | 45 | | | | |
| Exact ® 4049 | 1-butene/ | 0.873 | 67 | 4.5 | Some |
| | 28 | | | | |
| Affinity ® PL | 1-octene/ | 0.900 | 26 | 6.0 | None |
| 1280 | 13 | | | | |
| (comparative) | | | | | |

Each of the polymers listed in Table 1 were used in the preparation of six different 4-mil-thick, two-layer films, with each first layer of each film having a thickness of 2 mils, and each second layer having a thickness of 2 mils, each of the films being prepared in the same manner described in Example 1, above. In each of the six different films made, the first layer was 100% by weight of one of the six polymers identified in Table 1, above. The 4-mil film of Example 1 was added to the set of six films, making a total of seven films to be tested and compared.

In a first set of tests of the films, strips were cut from each of the films and tested by conducting repeated pressure-induced sealing of the first layer of each of the strips, the pressure-induced sealing being carried out at 30° C. and 40psi for one second, in the manner described above. The same areas of the first layers of the film strips were repeatedly subjected to pressure-induced sealing and then pulled apart during seal strength testing, also in the manner described above.

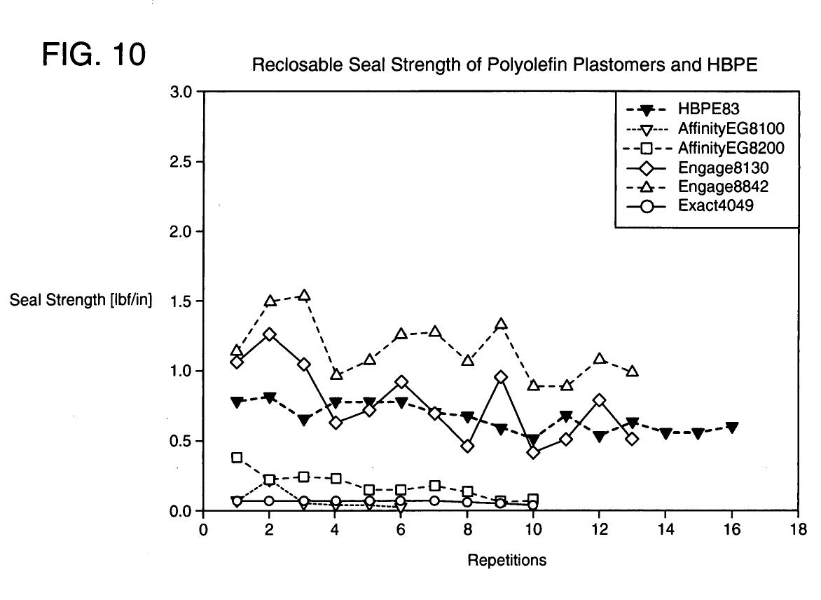

The reclosable seal strength results of 12 to 15 repetitions of five of the seven films (i.e., all but the Affinity® PL 1280, which did not have adequate tack, and HBPE 83, which is set forth in FIG. 4) are set forth in FIG. 10. In each case, the bonded pairs of film strips were allowed to age for at least one hour before seal strength testing at room temperature. Characterization of the reclosable seal strength for the films containing the various elastomers is provided in the right hand column of Table 1, above.

In a second set of tests, a set of pairs of film strips from six of the seven films (i.e., all of the films except the film having a first layer of 100 weight percent Affinity® PL 1280, which did not exhibit adequate tack for further testing) were subjected to pressure-induced sealing at 30° C., and heat sealing at the following temperatures: 50° C., 70° C., 90° C., 110° C., and 130° C., in each case using the sealing apparatus and method described in Example 1. The seal bars remained in contact with the film strips for 1 second in the making of each seal. After being allowed to age for at least one hour, the strength of each of the seals was tested at room temperature using the same seal strength testing apparatus described in Example 1.

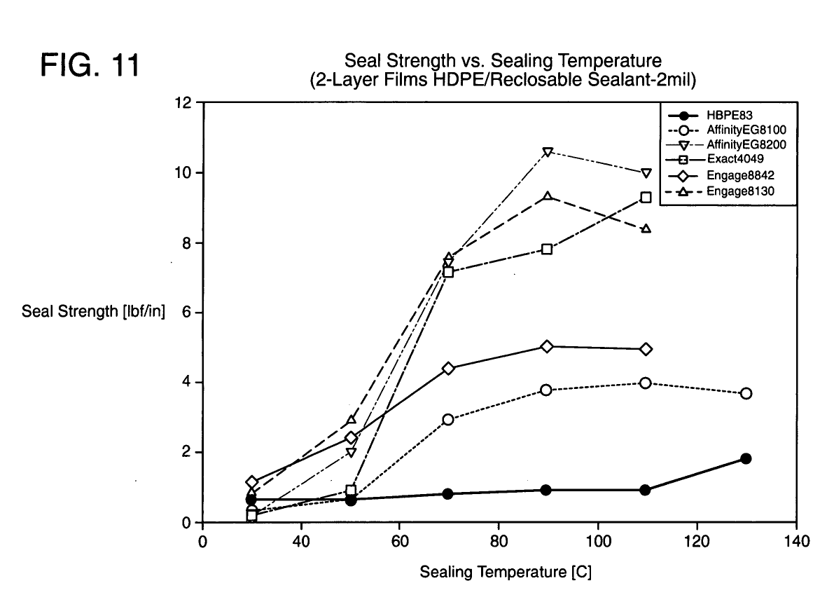

A plot of the seal strength as a function of temperature is set forth in FIG. 11. For all of the polyolefin elastomers tested, the seal strength of heat seals made at a temperature of 70° C. through 110° C. or 130° C. was significantly higher than the seal strength of the HBPE 83. This indicates that the polyolefin elastomers appear to be better candidates than HBPE 83 for a reclosable package which benefits from a strong initial heat seal, i.e., a strong seal before initial opening of the package.

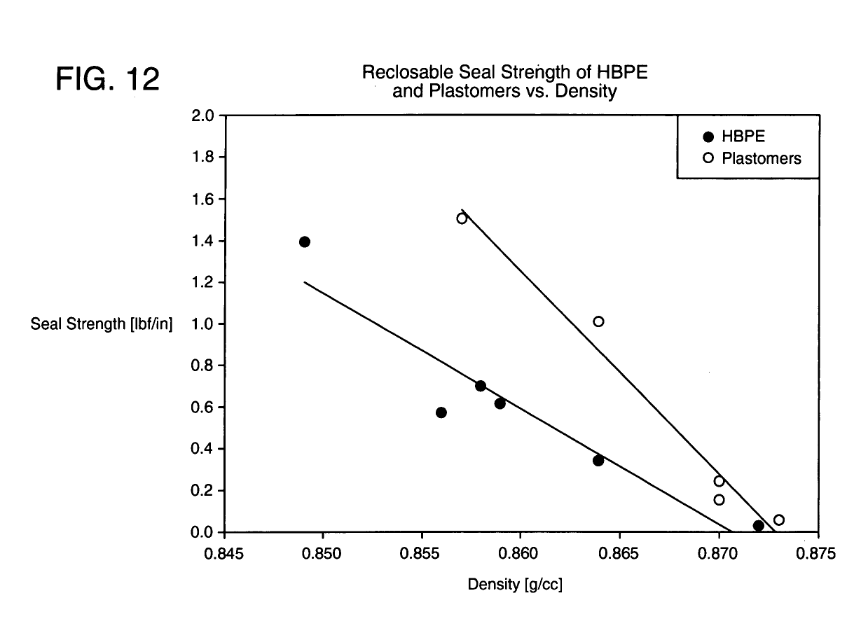

In FIG. 12, the density of various HBPE resins and elastomers is plotted against pressure-induced seal strength for the 4 mil elastomer-containing films described above, as well as various 4-mil films having first layers of 100% of a HBPE with a second layer of high density polyethylene. The elastomers include all of the elastomers identified in Table 1, above (i.e., all but the Affinity® PL 1280).

FIG. 12 shows the relationship between reclosable seal strength and density of various hyperbranched polyethylene resins as well as the various polyolefin elastomers identified in Table 1, above. While both hyperbranched polyethylene resins and polyolefin elastomers were tacky and formed reclosable seals when the density was about 0.87 g/cc or below, the reclosable seal strength increased with decreasing density. Moreover, the density reduction of the elastomers exhibited a greater effect on pressure-induced seal strength than for the HBPE resins. FIG. 12 illustrates this property in that the slope of the curve for the elastomers is greater than the slope for the HBPE's. Finally, the results provided in FIG. 12 indicate that density reduction may depend more on type and length of branches than on total branching level.

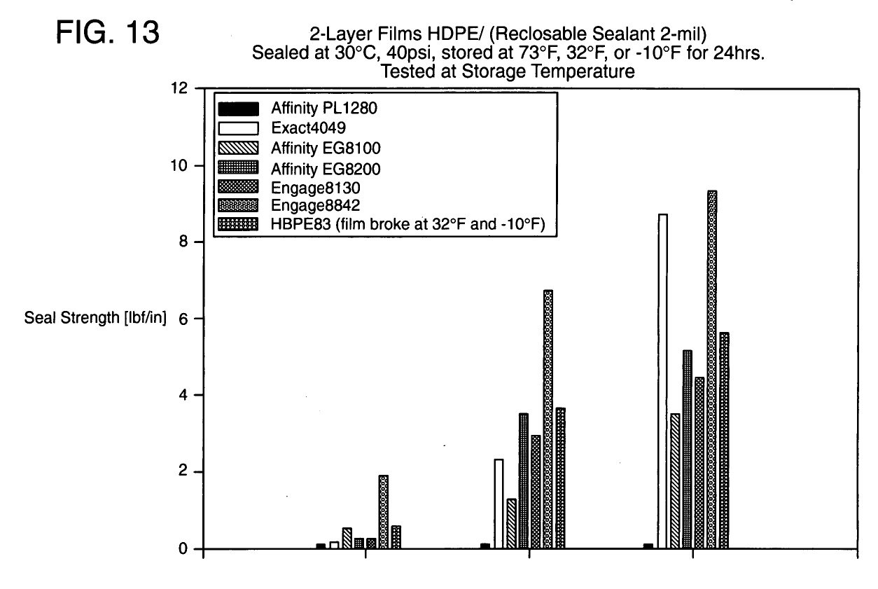

Film strips were cut from each of the seven two-layer films (i.e., the films of the six resins in Table 1 above, and the HBPE 83 film of Example 1), with the seal strength of pressure-induced seals being tested as a function of temperature, i.e., as described above in Example 1 and as represented by FIG. 6. The seal strength results are set forth lo in FIG. 13.

As can be seen in FIG. 13, the strength of the pressure-induced seal of the films of Examples 8-12 increased significantly as the temperature dropped from 22.8° C. to 0° C., and increased further as the temperature dropped from 0° C. to −23.3° C. The examples show the operability of the invention over a range of density, melt index, and branching level, for both the HBPE containing film as well as the films containing each of the elastomers identified in Table 1. However, the Affinity® PL 1280 did not exhibit an increase in seal strength as a function of decrease in temperature.

All subranges of all disclosed ranges are hereby expressly disclosed. All references herein to ASTM procedures are hereby incorporated, in their entireties, by reference thereto. Although the present invention has been described in conjunction with certain preferred embodiments, it is to be understood that modifications and variations may be utilized without departing from the principles and scope of the invention, as those skilled in the art will readily understand. Accordingly, such modifications may be practiced within the scope of the following claims.

1. A process for preparing and using a packaged product, comprising:
(A) packaging a product in a pressure-reclosable package which substantially surrounds the product, the reclosable package comprising a multilayer film comprising a heat-sealable, pressure-reclosable inside layer comprising at least one member selected from the group consisting of:
(i) a hyperbranched polyolefin having at least 70 side chain branches per 1000 carbon atoms and a density of up to about 0.885 g/cc; and
(ii) an ethylene/alpha-olefin elastomer having a density of up to about 0.885 g/cc; the multilayer film further comprising a second layer having a different polymeric composition, with the reclosable package being closed by sealing the inside layer to itself and/or a different component of the package so that a closed package is produced;
(B) opening the package whereby an opened package is formed;
(C) removing from the package at least a portion of the product which is to be used or consumed, with a remainder of the product being left inside the opened package and/or returned to the opened package; and
(D) re-closing the opened package by pressing the pressure-reclosable inside layer against itself or any other component of the package, the re-closing of the opened package being carried out while at least a portion of the multilayer film which is being re-closed is at a temperature of at least 11° C., the re-closing of the package forming a pressure-induced seal of the inside layer to itself or any other component of the package, whereby a pressure-reclosed package is formed, the pressure-reclosed seal having an initial seal strength at room temperature of from about 0.05 pounds force per inch to about 2 pounds force per inch; and
(E) placing the pressure-reclosed package in an environment having a temperature of from about −50° C. to +10° C., so that a cooled pressure-reclosed seal is formed, the cooled pressure-reclosed seal having a seal strength of at least double [at least 400 percent, at least 600; 200 to 5000 percent; 400 to 3000;

600 to 2500] the initial seal strength, the cooled reclosed seal having a seal strength of from about 2 pounds force per inch to about 20 pounds force per inch.

2. The process according to claim 1, wherein the package is closed by hermetically heat-sealing the inside layer to itself or the different component of the package.

3. The process according to claim 1, wherein the heat-sealable, pressure-reclosable inside layer comprises a blend which comprises:
(A) from about 15 to 99 percent, based on layer weight, of at least one member selected from the group consisting of the homogeneous hyperbranched polyolefin and the ethylene/alpha-olefin elastomer;
(B) from about 1 to about 85 percent, based on layer weight, of at least one polymer selected from the group consisting of an olefin homopolymer having a density of at least 0.88 g/cc and an olefin copolymer having a density of at least 0.88 g/cc.

4. The process according to claim 3, wherein the olefin copolymer in the blend comprises ethylene/alpha-olefin copolymer having a density of from 0.88 g/cc to 0.96 g/cc.

5. The process according to claim 1, wherein the ethylene/alpha-olefin elastomer comprises a homogeneous copolymer of ethylene and an alpha-olefin having from 4 to 20 carbon atoms.

6. The process according to claim 5, wherein the homogeneous copolymer comprises metallocene-catalyzed ethylene/alpha-olefin copolymer.

7. The process according to claim 6, wherein the metallocene-catalyzed ethylene/alpha-olefin copolymer comprises linear homogeneous ethylene/alpha-olefin copolymer.

8. The process according to claim 6, wherein the metallocene-catalyzed ethylene/alpha-olefin copolymer comprises long chain branched homogeneous ethylene/alpha-olefin copolymer.

9. The process according to claim 1, wherein the homogeneous hyperbranched polyolefin comprises hyperbranched ethylene homopolymer.

10. The process according to claim 1, wherein the homogeneous hyperbranched polyolefin comprises a homogeneous copolymer of ethylene and at least one member selected from the group consisting of propylene, butene, hexene, and octene.

11. The process according to claim 1, wherein when the pressure-reclosable inside layer is pressed against itself or the different component of the package at a pressure of at least 40 psi for one second at a temperature of 30° C., and the pressure-reclose seal has a seal strength of at least 100 grams per centimeter.

12. The process according to claim 1, wherein the multilayer film further comprises a third layer which serves as an O₂-barrier layer.

13. The process according to claim 1, wherein the hyperbranched polyolefin has from about 70 to about 140 side chain branches per 1000 carbon atoms.

14. The process according to claim 1, wherein the second layer comprises at least one member selected from the group consisting of polyolefin homopolymer, ethylene/alpha-olefin copolymer, polyamide, polyester, ethylene/vinyl alcohol copolymer, halogenated polymer, polystyrene, polynorbomene, ethylene/ester copolymer, and ethylene/unsaturated acid polymer.

15. The process according to claim 1, wherein the hyperbranched polyolefin comprises hyperbranched polyethylene having a density of from about 0.85 to 0.87 g/cm .

16. The process according to claim 1, wherein the heat-sealable, pressure-reclosable layer comprises hyperbranched polyolefin in an amount of 100 percent, based on layer weight.

17. The process according to claim 1, wherein the heat-sealable, pressure-reclosable layer comprises the ethylene/alpha-olefin elastomer an amount of 100 percent, based on layer weight.

18. The process according to claim 1, wherein the multilayer film has a total free shrink, at 185° F., of at least 10 percent.

19. The process according to claim 1, wherein the multilayer film has a thickness of from about 0.3 to 25 mils.

20. The process according to claim 1, wherein the product comprises food.

21. The process according to claim 1, wherein the food comprises at least one member selected from the group consisting of meat, cheese, ice cream, produce, dairy products, spices, and condiments.

22. The process according to claim 1, wherein the package comprises at least one member selected from the group consisting of bag, pouch, casing, tray having flange with film lid adhered to flange, formed packaging article, and box.

23. A process for preparing and using a packaged product, comprising:
(A) packaging a product in a reclosable package which substantially surrounds the product, the reclosable package comprising a multilayer film comprising a heat-sealable, pressure-reclosable inside layer comprising at least one member selected from the group consisting of:
(i) a hyperbranched polyolefin having at least 70 side chain branches per 1000 carbon atoms and a density of up to about 0.885 g/cc; and
(ii) an ethylene/alpha-olefin elastomer having a density of up to about 0.885 g/cc;
the multilayer film further comprising a second layer comprising a different polymer, with the reclosable package being closed by heat sealing the inside layer to itself or a different component of the package so that a closed package is produced,
(B) storing the closed package in a first environment, the first environment being at a temperature of from about −50° C. to 10° C.;
(C) moving the closed package from the first environment into a second environment, the second environment being at a temperature of from 11° C. to 45° C.;
(D) opening the package while the package is in the second environment, whereby an opened package is formed;
(E) removing from the package at least a portion of the product which is to be used or consumed, with a remainder of the product being left inside the opened package and/or returned to the opened package; and
(F) re-closing the opened package by pressing the pressure-reclosable inside layer against itself or any other component of the package, the re-closing of the opened package being carried out while the package remains in the second environment, the re-closing of the package forming a pressure-induced seal of the inside layer to itself or any other component of the package, whereby a pressure-reclosed package is formed, the pressure-reclosed package substantially surrounding the remainder of the product, the pressure-reclosed seal having an initial seal strength of from about 0.05 pounds force per inch to about 2 pounds force per inch in the second environment; and
(G) returning the pressure-reclosed package to the first environment whereby a cooled pressure-reclosed seal is formed, the cooled pressure-reclosed seal having a seal strength of at least double the initial seal strength, the cooled reclosed seal having a seal strength of from about 2 pounds force per inch to about 20 pounds force per inch.
As a second aspect, the process of the present invention can utilize a packaging article having a reclosable strip component which is adhered to another component of the package, the reclosable strip containing the hyperbranched polyolefin and/or the ethylene/alpha-olefin elastomer on an outer surface which adheres to another component of the package.
